(19) United States
(12) Patent Application Publication
(10) Pub. No.: US 2025/0003323 A1
(43) Pub. Date: Jan. 2, 2025

(54) In-Situ Hydrogen Generation and Production From Petroleum Reservoirs

(71) Applicant: Texas Tech University System, Lubbock, TX (US)

(72) Inventors: Qingwang Yuan, Wolfforth, TX (US); Bo Ren, Round Rock, TX (US)

(21) Appl. No.: 18/692,964

(22) PCT Filed: Sep. 20, 2022
(86) PCT No.: PCT/US2022/044109

§ 371 Date: Mar. 18, 2024

Related U.S. Application Data
(60) Provisional application No. 63/245,981, filed on Sep. 20, 2021.

(51) Int. Cl. E21B 43/295; C09K 8/80; E21B 41/00; E21B 43/16; E21B 43/24; E21B 43/267; E21B 43/38; E21B 43/40

(52) U.S. Cl. CPC E21B 43/295; C09K 8/80; E21B 41/0064; E21B 43/164; E21B 43/2401; E21B 43/267; E21B 43/385; E21B 43/40

(57) ABSTRACT

A system and method for generating hydrogen within a petroleum reservoir and producing the hydrogen includes providing one or more wellbores into the petroleum reservoir from a surface, wherein the petroleum reservoir contains fractures by hydraulic fracturing, heating catalyst particles within the fractures of the petroleum reservoir using electromagnetic waves, wherein the heated catalyst particles generate a syngas from hydrocarbons within the petroleum reservoir, separating the hydrogen from the syngas at the surface or within the one or more wellbores, and producing the hydrogen at the surface or to the surface.

### CROSS-REFERENCE TO RELATED APPLICATIONS

This application claims priority to U.S. Provisional Application Ser. No. 63/245,981, filed Sep. 20, 2021, the entire contents of which are incorporated herein by reference.

### TECHNICAL FIELD OF THE INVENTION

The present invention relates in general to the field of petroleum production, and more particularly, to generating and producing hydrogen (H₂) gas directly from petroleum reservoirs.

### STATEMENT OF FEDERALLY FUNDED RESEARCH

None.

### BACKGROUND OF THE INVENTION

Without limiting the scope of the invention, its background is described in connection with developing petroleum reservoirs for clean hydrogen energy.

Petroleum has been continuously produced from reservoirs in the form of gas, liquid, or solid for many years. Vertical and horizontal wells are typically drilled to allow oil and gas to flow from formation to surface.

Different technologies have been developed for conventional reservoirs, heavy oil reservoirs, and unconventional reservoirs in the stage of primary, secondary, and tertiary recovery. For example, microwave heating is used for improving the recovery of heavy oil and oil shale. For unconventional shale reservoirs, the hydraulic fracturing is usually performed to create highly permeable fractures for shale oil and/or shale gas flow into wellbores. The ultimate objective of these technologies is to produce hydrocarbons as much as possible.

However, the burning of petroleum emits huge amount of carbon dioxide (CO₂) to the atmosphere, which is blamed for the main reason of global warming. One way to reduce CO₂ emission is to convert hydrocarbons, such as methane, to hydrogen (H₂) at the surface by the steam methane reforming (SMR) and capture the by-product CO₂ and sequestrate it into reservoirs. However, this technology generates 20% more emissions over its life cycle than simply burning natural gas (Howarth and Jacobson, 2021).

According there is a need for a hydrogen generation process that can be conducted within petroleum reservoirs using the abundant hydrocarbons and water in reservoirs such that hydrogen is produced to the surface from the production well and emissions are significantly reduced.

### SUMMARY OF THE INVENTION

Various embodiments of the present invention generate and produce high-purity hydrogen directly from petroleum reservoirs using electromagnetic wave (e.g., microwaves, etc.) heating in the presence of catalysts, which are delivered deeply into the reservoirs through adapting hydraulic fracturing processes. The whole process can happen in underground reservoirs, instead of at the surface facilities. It is for hydrogen generation and production, rather than for enhanced oil or gas recovery in traditional petroleum industry.

In one embodiment, a method generates hydrogen within a petroleum reservoir and produces the hydrogen. One or more wellbores into the petroleum reservoir from a surface are provided, wherein the petroleum reservoir contains fractures by hydraulic fracturing. Catalyst particles are heated within the fractures of the petroleum reservoir using electromagnetic waves, wherein the heated catalyst particles generate a syngas from hydrocarbons within the petroleum reservoir. The hydrogen is separated from the syngas at the surface or within the one or more wellbores, and the hydrogen is produced at the surface or to the surface.

In one aspect, the one or more wellbores further comprise one or more horizontal wellbores. In another aspect, the one or more horizontal wellbores comprise one or more upper side wells and one or more lower side wells. In another aspect, the heating is performed using the one or more lower side wells, and the syngas is produced using the one or more upper side wells. In another aspect, one or more antennas are positioned within the petroleum reservoir, wherein the one or more antennas are connected to a power source at the surface, and the electromagnetic waves are generated using one or more antennas. In another aspect, the catalyst particles proximate to the one or more antennas are heated to a temperature of up to 1000° C., and a rock or hydrocarbons within the petroleum reservoir are heated to a temperature of about 100° C. to up to 800° C. In another aspect, the electromagnetic waves are continuous, pulsed, intermittent, time dependent or time independent. In another aspect, the catalyst particles are heated for a time period of hours, days, seasons or years. In another aspect, the electromagnetic waves have a frequency from about 100 Hz to about 100 GHZ. In another aspect, the frequency is adjusted according to saturations of water, oil and gas in the hydrocarbon reservoir. In another aspect, the syngas comprises the hydrogen, carbon monoxide and carbon dioxide. In another aspect, the hydrogen comprises a mixture of the hydrogen and methane. In another aspect, further comprising the mixture of the hydrogen and the methane is separated from the syngas using membrane separators, and co-transporting the mixture of the hydrogen and the methane using natural gas pipelines. In another aspect, CO₂ is injected or sequestered in the petroleum reservoir. In another aspect, the catalyst particles comprise iron catalysts, nickel catalysts, or titanium oxide (TO), a size of the catalyst particles ranges from nanometers to millimeters; or a shape of catalysts comprises tri-lobe, spherical, or agglomerated. In another aspect, the catalyst particles are injected into the fractures within the petroleum reservoir in a continuous, pulsed, or slug manner. In another aspect, the catalyst particles are contained within a polymer fluid. In another aspect, the catalyst particles are injected a pressure greater than a fracturing pressure of the petroleum reservoir. In another aspect, a buffer fluid is injected into the petroleum reservoir. In another aspect, support materials or propping agents are also injected into the fractures. In another aspect, the support materials comprise activated carbon (AC) or silicon carbide (SiC). In another aspect, a ratio of the proppant agents to the catalyst particles comprises a range of about 0 to 100%. In another aspect, steam or water is injected into the hydrocarbon reservoir to re-generate the catalyst particles in-situ by removing coke deposited on a surface of the catalysts or in the fractures. In another aspect, the fractures within the petroleum reservoir are created using hydraulic fracturing. In another aspect, the petroleum reservoir is re-fractured and the catalyst particles are replaced in the petroleum reservoir.

In another embodiment, a system for generating hydrogen within a petroleum reservoir and producing the hydrogen includes one or more wellbores into the petroleum reservoir from a surface, wherein the petroleum reservoir contains fractures by hydraulic fracturing, a power source at the surface, one or more antennas within the petroleum reservoir and connected to the power source, catalyst particles within the fractures of the petroleum reservoir, and one or more hydrogen separators located within the one or more wellbores or at the surface. The one or more antennas generate electromagnetic waves that heat the catalyst particles, which generate a syngas from hydrocarbons within the petroleum reservoir. The one or more hydrogen separators separate the hydrogen from the syngas.

In one aspect, the one or more wellbores further comprise one or more horizontal wellbores. In another aspect, the one or more horizontal wellbores comprise one or more upper side wells and one or more lower side wells. In another aspect, the heating is performed using the one or more lower side wells, and the syngas is produced using the one or more upper side wells. In another aspect, the catalyst particles proximate to the one or more antennas are heated to a temperature of up to 1000° C., and a rock or hydrocarbons within the petroleum reservoir are heated to a temperature of about 100° C. to up to 800° C. In another aspect, the electromagnetic waves are continuous, pulsed, intermittent, time dependent or time independent. In another aspect, the catalyst particles are heated for a time period of hours, days, seasons or years. In another aspect, the electromagnetic waves have a frequency from about 100 Hz to about 100 GHz. In another aspect, the frequency is adjusted according to saturations of water, oil and gas in the hydrocarbon reservoir. In another aspect, the syngas comprises the hydrogen, carbon monoxide and carbon dioxide. In another aspect, the hydrogen comprises a mixture of the hydrogen and methane. In another aspect, the one or more hydrogen separators comprise one or more membrane separators, and a natural gas pipeline is coupled to the one or more wellbores or the one or more membrane separators at the surface that co-transport the mixture of the hydrogen and the methane. In another aspect, CO₂ is injected or sequestered in the petroleum reservoir. In another aspect, the catalyst particles comprise iron catalysts, nickel catalysts, or titanium oxide (TO). A size of the catalyst particles ranges from nanometers to millimeters, or a shape of catalysts comprises tri-lobe, spherical, or agglomerated. In another aspect, the catalyst particles are injected into the fractures within the petroleum reservoir in a continuous, pulsed, or slug manner. In another aspect, the catalyst particles are contained within a polymer fluid. In another aspect, the catalyst particles are injected a pressure greater than a fracturing pressure of the petroleum reservoir. In another aspect, a buffer fluid is injected into the petroleum reservoir. In another aspect, support materials or propping agents are also injected into the fractures. In another aspect, the support materials comprise activated carbon (AC) or silicon carbide (SIC). In another aspect, a ratio of the proppant agents to the catalyst particles comprises a range of about 0 to 100%. In another aspect, steam or water is injected into the hydrocarbon reservoir to re-generate the catalyst particles in-situ by removing coke deposited on a surface of the catalysts or in the fractures. In another aspect, the fractures within the petroleum reservoir are created using hydraulic fracturing. In another aspect, the petroleum reservoir is re-fractured and the catalyst particles in the petroleum reservoir are replaced.

Note that the invention is not limited to the embodiments, instead it has the applicability beyond the embodiments herein. The brief and detailed descriptions of this invention are given in the following.

### BRIEF DESCRIPTION OF THE DRAWINGS

For a more complete understanding of the features and advantages of the present invention, reference is now made to the detailed description of the invention along with the accompanying figures and in which:

FIG. 1 is a flow chart of a method in accordance with one embodiment of the present invention;

FIG. 2 is a diagram of a system in accordance with one embodiment of the present invention:

FIG. 3 is a diagram of a hydraulic fracturing process:

FIG. 4 is a diagram showing the placement of catalysts where the mixtures of propping agents and catalyst particles are pumped into the fractures through wells in accordance with one embodiment of the present invention:

FIG. 5 is a diagram showing the pumping back of fracturing fluids in accordance with one embodiment of the present invention:

FIG. 6 is a diagram showing syngas (e.g., hydrogen, CO, and other gases) generated in a shale reservoir by radiofrequency/microwave heating in the presences of hydrocarbons, water, and catalysts, and the generated hydrogen is produced from a horizontal well in accordance with one embodiment of the present invention;

FIG. 7 is a diagram showing syngas is generated and flows upward under buoyancy in a conventional reservoir in which hydrogen is produced from both an upper side well and lower side well in accordance with one embodiment of the present invention;

FIG. 8 is a diagram showing hydrogen or the mixture of hydrogen and methane is produced to surface with the help of a downhole hydrogen membrane separator in a shale reservoir in accordance with one embodiment of the present invention:

FIG. 9 is a diagram showing hydrogen or the mixture of hydrogen and methane is produced to surface with the help of downhole hydrogen membrane separators installed on both the upper side well and the lower side well in a conventional reservoir in accordance with one embodiment of the present invention;

FIG. 10 is a diagram showing a process to mitigate coke deposition and to re-activate catalysts by injecting water or steam in accordance with one embodiment of the present invention:

FIG. 11 is a diagram showing the ultimate hydrogen purity in generated gases and the ultimate hydrogen generation selectivity, mL H₂/g crude oil in accordance with one embodiment of the present invention:

FIG. 12 is a diagram showing the percentage of generated gases in lab experiments in accordance with one embodiment of the present invention:

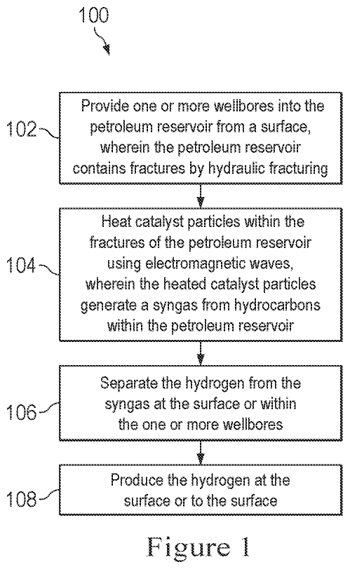

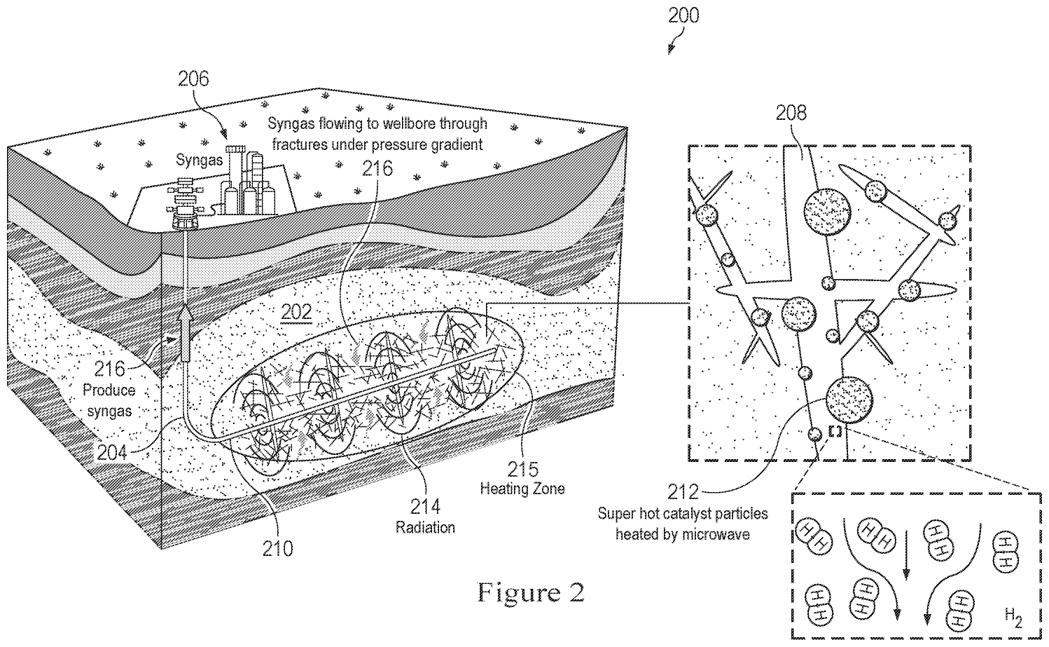

Table 1 shows the combinations of the materials used for hydrogen generation using microwave heating in lab experiments in accordance with one embodiment of the present invention:

Table 2 shows the mass change and gas production during lab experiments in accordance with one embodiment of the present invention; and

Table 3 shows the compositions of generated gases in lab experiments in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various methods are described below to provide an example of each claimed embodiment. They do not limit any claimed embodiment. Any claimed embodiment may cover methods that are different from those described above and below. The drawings and descriptions are for illustrative, rather than restrictive, purposes.

In this invention, the terms, expressions, and statements are used according to their ordinary meanings. The additional terms are defined in the following.

The term “petroleum reservoirs”, as used herein, is intended to be the petroleum formation that composes of porous rock, water, oil, and/or gas at the certain depth below the surface. The reservoirs refer to, but not limited to, the conventional sandstone and carbonate reservoirs, heavy oil and bitumen reservoirs, shale oil and shale gas reservoirs, and oil shale reservoirs.

The terms “hydrocarbons”, “petroleum”, and “oil and gas”, as used herein, are used interchangeably. They refer to the organic compounds that compose of hydrogen, carbon, and other elements.

The terms “electromagnetic” and “radiofrequency/microwave” are used interchangeably.

The term “catalyst particles”, as used herein, is intended to be, but not limited to, iron catalysts, nickel catalysts, titanium oxide (TO), and support materials such as activated carbon (AC) and silicon carbide (SiC). The catalysts with better radiofrequency/microwave absorbing capability are preferred. The size of catalyst particles ranges from nanometers to millimeters. The shape of catalysts includes, but not limited to, tri-lobe, spherical, and agglomerated.

The term “syngas”, as used herein, refers to a fuel gas mixture generated at high temperature during and after microwave heating in reservoirs. The syngas consists primarily of hydrogen, carbon monoxide, and a little carbon dioxide and hydrocarbon gas.

Various embodiments of the present invention generate and produce high-purity hydrogen directly from petroleum reservoirs using electromagnetic wave heating (e.g., microwaves, etc.) in the presence of catalysts, which are delivered deeply into the reservoirs through adapting hydraulic fracturing processes. The whole process can happen in underground reservoirs, instead of at the surface facilities. It is for hydrogen generation and production, rather than for enhanced oil or gas recovery in traditional petroleum industry.

In one embodiment, a method 100 generates hydrogen within a petroleum reservoir and produces the hydrogen. One or more wellbores into the petroleum reservoir from a surface are provided in 102, wherein the petroleum reservoir contains fractures by hydraulic fracturing. Catalyst particles are heated within the fractures of the petroleum reservoir using electromagnetic waves in block 104, wherein the heated catalyst particles generate a syngas from hydrocarbons within the petroleum reservoir. The hydrogen is separated from the syngas at the surface or within the one or more wellbores in block 106, and the hydrogen is produced at the surface or to the surface in block 108.

In one aspect, the one or more wellbores further comprise one or more horizontal wellbores. In another aspect, the one or more horizontal wellbores comprise one or more upper side wells and one or more lower side wells. In another aspect, the heating is performed using the one or more lower side wells, and the syngas is produced using the one or more upper side wells. In another aspect, one or more antennas are positioned within the petroleum reservoir, wherein the one or more antennas are connected to a power source at the surface, and the electromagnetic waves are generated using one or more antennas. In another aspect, the catalyst particles proximate to the one or more antennas are heated to a temperature of up to 1000° C., and a rock or hydrocarbons within the petroleum reservoir are heated to a temperature of about 100° C. to up to 800° C. In another aspect, the electromagnetic waves are continuous, pulsed, intermittent, time dependent or time independent. In another aspect, the catalyst particles are heated for a time period of hours, days, seasons or years. In another aspect, the electromagnetic waves have a frequency from about 100 Hz to about 100 GHZ. In another aspect, the frequency is adjusted according to saturations of water, oil and gas in the hydrocarbon reservoir. In another aspect, the syngas comprises the hydrogen, carbon monoxide and carbon dioxide. In another aspect, the hydrogen comprises a mixture of the hydrogen and methane. In another aspect, the method further comprises the mixture of the hydrogen and the methane is separated from the syngas using membrane separators, and co-transporting the mixture of the hydrogen and the methane using natural gas pipeline. In another aspect, CO₂ is injected or sequestered in the petroleum reservoir. In another aspect, the catalyst particles comprise iron catalysts, nickel catalysts, or titanium oxide (TO), a size of the catalyst particles ranges from nanometers to millimeters; or a shape of catalysts comprises tri-lobe, spherical, or agglomerated. In another aspect, the catalyst particles are injected into the fractures within the petroleum reservoir in a continuous, pulsed, or slug manner. In another aspect, the catalyst particles are contained within a polymer fluid. In another aspect, the catalyst particles are injected a pressure greater than a fracturing pressure of the petroleum reservoir. In another aspect, a buffer fluid is injected into the petroleum reservoir. In another aspect, support materials or propping agents are also injected into the fractures. In another aspect, the support materials comprise activated carbon (AC) or silicon carbide (SiC). In another aspect, a ratio of the proppant agents to the catalyst particles comprises a range of about 0 to 100%. In another aspect, steam or water is injected into the hydrocarbon reservoir to re-generate the catalyst particles in-situ by removing coke deposited on a surface of the catalysts or in the fractures. In another aspect, the fractures within the petroleum reservoir are created using hydraulic fracturing. In another aspect, the petroleum reservoir is re-fractured and the catalyst particles are replaced in the petroleum reservoir.

In another embodiment, a system 200 for generating hydrogen within a petroleum reservoir 202 and producing the hydrogen includes one or more wellbores 204 into the petroleum reservoir 202 from a surface 206, wherein the petroleum reservoir 202 contains fractures 208 by hydraulic fracturing, a power source at the surface 206, one or more antennas 210 within the petroleum reservoir 202 and connected to the power source, catalyst particles 212 within the fractures of the petroleum reservoir 202, and one or more hydrogen separators located within the one or more wellbores 204 or at the surface 206. The one or more antennas 210 generate electromagnetic waves (radiation) 214 creating a heating zone 215 that heats the catalyst particles 212, which generate a syngas 216 from hydrocarbons within the petroleum reservoir 202. The one or more hydrogen separators separate the hydrogen from the syngas 216.

In one aspect, the one or more wellbores further comprise one or more horizontal wellbores. In another aspect, the one or more horizontal wellbores comprise one or more upper side wells and one or more lower side wells. In another aspect, the heating is performed using the one or more lower side wells, and the syngas is produced using the one or more upper side wells. In another aspect, the catalyst particles proximate to the one or more antennas are heated to a temperature of up to 1000° C., and a rock or hydrocarbons within the petroleum reservoir are heated to a temperature of about 100° C. to up to 800° C. In another aspect, the electromagnetic waves are continuous, pulsed, intermittent, time dependent or time independent. In another aspect, the catalyst particles are heated for a time period of hours, days, seasons or years. In another aspect, the electromagnetic waves have a frequency from about 100 Hz to about 100 GHz. In another aspect, the frequency is adjusted according to saturations of water, oil and gas in the hydrocarbon reservoir. In another aspect, the syngas comprises the hydrogen, carbon monoxide and carbon dioxide. In another aspect, the hydrogen comprises a mixture of the hydrogen and methane. In another aspect, the one or more hydrogen separators comprise one or more membrane separators, and a natural gas pipeline is coupled to the one or more wellbores or the one or more membrane separators at the surface that co-transport the mixture of the hydrogen and the methane. In another aspect, CO₂ is injected or sequestered in the petroleum reservoir. In another aspect, the catalyst particles comprise iron catalysts, nickel catalysts, or titanium oxide (TO). A size of the catalyst particles ranges from nanometers to millimeters, or a shape of catalysts comprises tri-lobe, spherical, or agglomerated. In another aspect, the catalyst particles are injected into the fractures within the petroleum reservoir in a continuous, pulsed, or slug manner. In another aspect, the catalyst particles are contained within a polymer fluid. In another aspect, the catalyst particles are injected a pressure greater than a fracturing pressure of the petroleum reservoir. In another aspect, a buffer fluid is injected into the petroleum reservoir. In another aspect, support materials or propping agents are also injected into the fractures. In another aspect, the support materials comprise activated carbon (AC) or silicon carbide (SiC). In another aspect, a ratio of the proppant agents to the catalyst particles comprises a range of about 0 to 100%. In another aspect, steam or water is injected into the hydrocarbon reservoir to re-generate the catalyst particles in-situ by removing coke deposited on a surface of the catalysts or in the fractures. In another aspect, the fractures within the petroleum reservoir are created using hydraulic fracturing. In another aspect, the petroleum reservoir is re-fractured and the catalyst particles in the petroleum reservoir are replaced.

As described above and further explained below, the method relates to generation and production of hydrogen from subsurface petroleum reservoirs using radiofrequency/microwave heating. The integration of hydraulic fracturing in this method allows the creation of fractures and fracture networks in petroleum reservoirs so that the catalyst particles and support materials in different sizes can be placed in both large and small fractures. The radiofrequency/microwave then directly deliver energy to these materials and locally heat them to very high temperatures (i.e., up to 1000° C. on catalyst particle surface). These materials, as well as water, preferentially absorb microwaves such that the reservoir rock and hydrocarbon can be heated to a high temperature ranging from about 100° C. to up to 800° C., depending on the distance from microwave antenna along the well and the distance from catalyst particles. Several reactions happen on the catalyst surface and rock pores in reservoirs at different temperatures including:
Hydrocarbon thermal cracking: CₓH_{y}→x C+y/2 H₂
Coke-water reaction: C+H₂O→CO+H₂
Water-gas-shift reaction: CO+H₂O→CO₂+H₂

The hydrogen and syngas are therefore generated. To produce high-value hydrogen, the gas mixtures are pumped to surface, separated, and then the byproduced CO₂ is injected into the reservoirs. Another way is to use a downhole hydrogen membrane separator that only allows hydrogen to pass through and then produce out, while all other gases, including CO₂, will be simultaneously sequestrated in reservoirs.

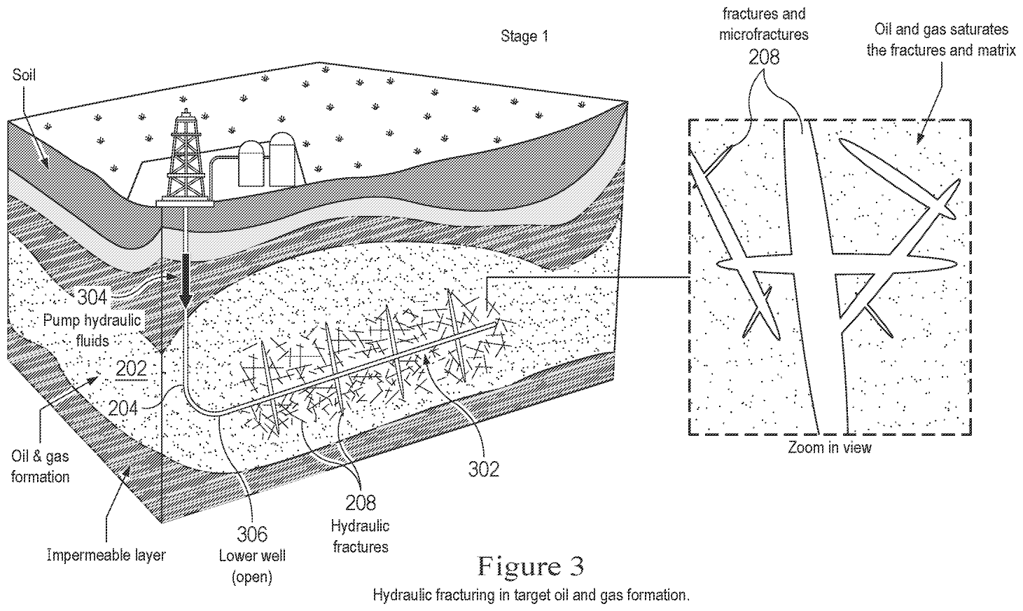

Referring to FIG. 3, a schematic diagram of the stage one which is a traditional hydraulic fracturing process where a single horizontal well 302 is used in a target reservoir 202 in accordance with one embodiment of the present invention is shown. Hydraulic fluids 304 are pumped into the lower well 306, which is open. When the pressure is above the fracturing pressure, the fractures 208 are created with both large and small fractures in an oil and gas formation 202. The oil and gas saturates the fractures 208 and matrix. In some embodiments, acid fluids are injected to create larger fractures for pumping more catalysts for in-situ hydrogen generation.

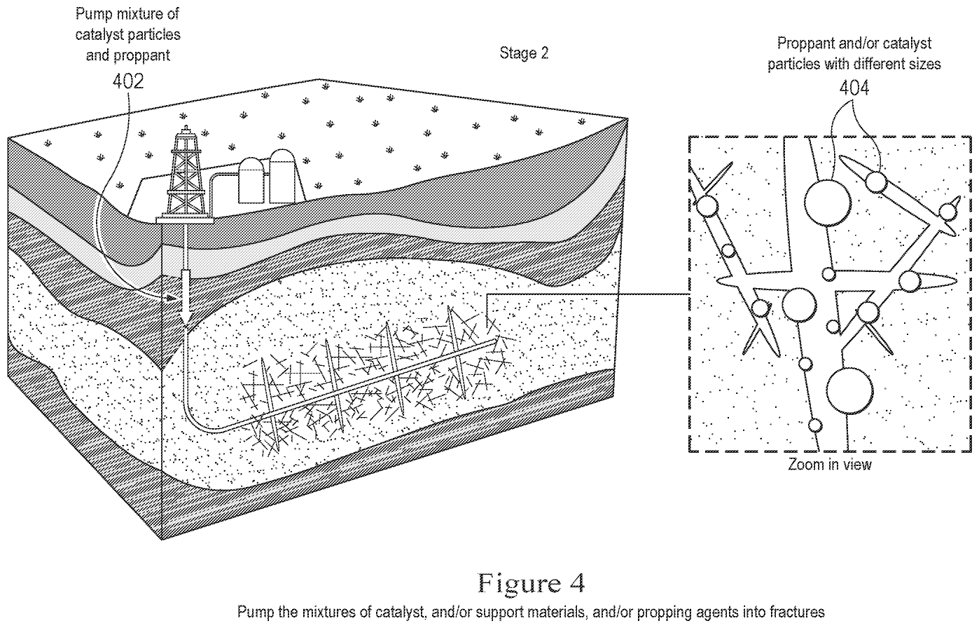

Turning to FIG. 4, a schematic of stage two for pumping mixtures of catalyst particles, support materials, and proppant in accordance with one embodiment of the present invention is shown. The downhole pressure is higher than the pressure of the target oil and gas formation so that the mixtures and fluids 402 will flow into the target formation under pressure gradient. Different sizes of proppants and/or catalyst particles 404 are used ranging from nanometers to millimeters. Larger catalysts particles act as both microwave absorbers and propping agents. Smaller catalyst particles (e.g., diameters below: 100 micrometers or even several nanometers) can be transported into smaller fractures in deeper formation.

In some embodiments, the mixtures of catalyst particles, support materials, and propping agents are pumped at a constant rate so that the mixtures continuously flow to the deeper oil and gas formation under pressure gradient.

In some embodiments, the mixtures of catalyst particles, support materials, and propping agents are pumped in a pulsed manner with an alternating high and low injection pressure and/or injection rate. This is favorable for pushing catalyst particles into deeper target formation.

In some embodiments, the pumping pressure is above the fracturing pressure so that new fractures are created, and more catalyst particles are placed into these fractures.

In some embodiments, a slug of mixtures of catalyst particles, support materials, and propping agents is injected, followed by cheap buffer fluids. This allows to push the mixtures into a deeper target formation and reduce the amount of usage of catalysts, support materials, and propping agents.

In some embodiments, polymers are used as fluids to more efficiently carry the mixtures of catalyst particles, support materials, and propping agents into deeper target formation.

In other embodiments, the ratio of proppant/catalyst ratio is varied to achieve better heating effects and save the usage of catalyst.

In stage two shown in FIG. 4, using different pumping schemes is helpful for more catalyst particles placed into the fractures in deeper formation and the reduction of the costs.

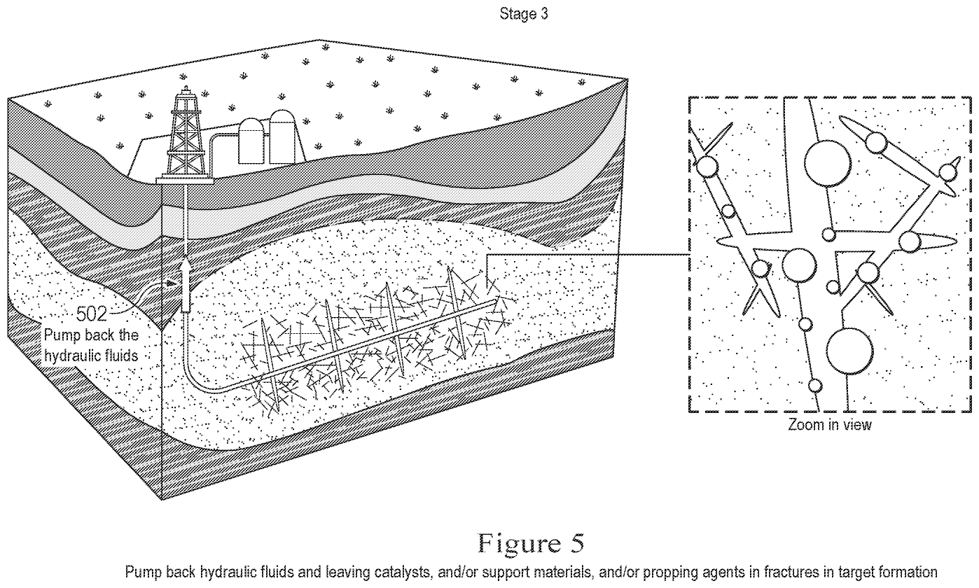

Referring now to FIG. 5, a schematic of stage 3 for pumping back the hydraulic fluids 502 in accordance with one embodiment of the present invention is shown. When downhole pressure is less than the pressure of target formation, the hydraulic fluids 502 flow back to wellbore under pressure gradient. The catalyst particles, support materials, and propping agents stay in the fractures in the fluid pumping back stage.

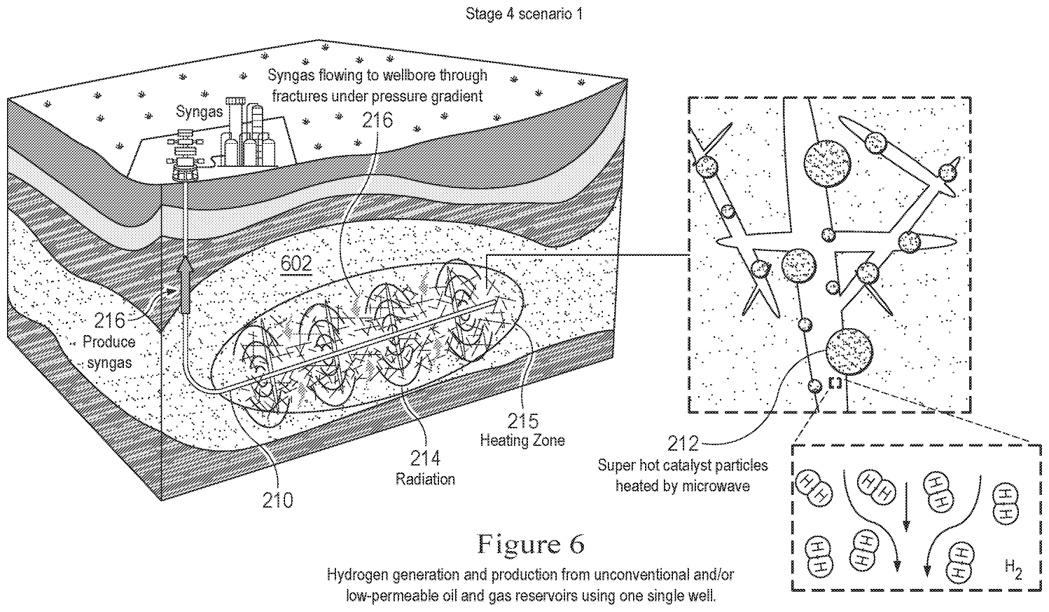

FIGS. 6 to 9 depict different scenarios for stage four.

Turning to FIG. 6, a schematic for scenario one for low permeability reservoirs 602, including but not limited to shale oil reservoir, shale gas reservoirs, and tight sandstone reservoirs in accordance with one embodiment of the present invention is shown. The permeability of such reservoir matrix is typically lower than 0.1 mD. The radiofrequency/microwave heating is started through the antenna 210, which is connected to surface electrical cables (not shown). The strong radiofrequency/microwave absorbing materials are preferentially heated such as the iron catalyst particles 212 and water. Note the iron catalyst particles 212 can be heated to as superhot spot with temperatures up to 1000° C. within a certain distance from the wellbore. Hydrogen and syngas are generated under such high pressure within reservoirs 602 through the hydrocarbon thermal cracking, coke-water reaction, and water-gas-shift reaction. Because of the very low permeability of the matrix and the very high permeability of fracture network, most gases flow to the wellbore under pressure gradient. The amount of gases flowing upward due to buoyancy is negligible. Hydrogen and syngas 216 are then produced to surface. The CO₂ in the syngas can be separated and then re-injected to reservoirs for CO₂ sequestration.

In some embodiments, the radiofrequency/microwave heating is continuous and will last for months to years until the oil and/or gas flowing to wellbore is too slow and not economic.

In some embodiments, the radiofrequency/microwave heating is in a pulsed manner with many heating/no-heating period or in an intermittent way. The length of a period can be one day, several days, or a season. The electricity for such radiofrequency/microwave heating is from peak-time electricity from renewable energy such as wind and solar energy which is out of the delivery capability of the grid.

In some embodiments, the electromagnetic waves create microfractures in matrix which can increase the permeability of matrix near the well, thus favorable for hydrogen and syngas flowing to wells.

In some embodiments, the electromagnetic frequency is adjusted by changing the settings at the surface according to the saturations of water, oil, and gas in a target formation. This allows the electromagnetic waves to penetrate and heat larger volume of formation for hydrogen generation.

In some embodiments, the downhole gas/liquid separator is used in the wellbore so that only hydrogen and/or syngas is produced, while the liquids such as water and oil remain in the target formation.

In some cases, there is solid coke deposition in matrix, fractures, and catalyst surface. They can de-activate catalysts. But the in-situ coke-water reaction can re-generate the catalysts. Another approach is to inject water or steam through the well to re-generate catalyst.

In some embodiments, under the high temperature by radiofrequency/microwave heating, the natural catalysts in rocks can enhance the hydrocarbon thermal cracking, coke-water reaction, and water-gas-shift reaction and generate more hydrogen.

In some cases, more of the water in reactions are from reservoir brine. Some hydrogen is also generated from water because of the water-gas-shift reaction.

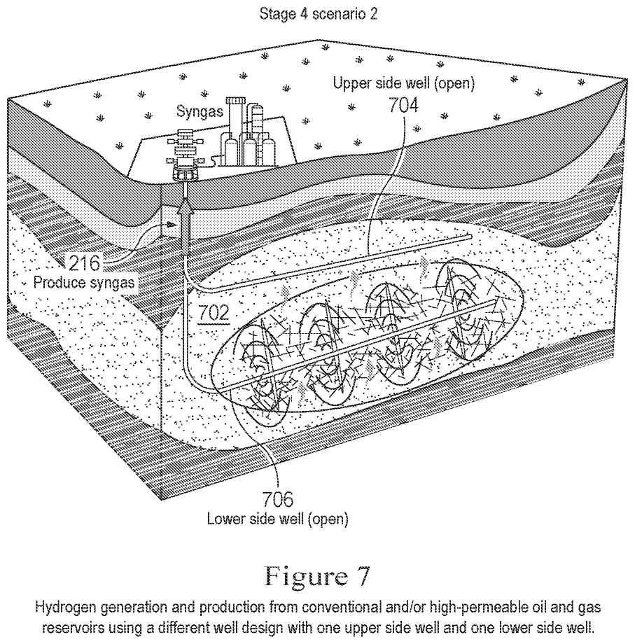

Referring now to FIG. 7, a schematic for stage four scenario two for hydrogen generation from high-permeable reservoirs 702, including but not limited to, conventional oil and gas reservoirs, and sandstone and carbonate reservoirs in accordance with one embodiment of the present invention is shown. One upper side well 704 and one lower side well 706 are drilled with the same wellhead, but the hydraulic fracturing and radiofrequency/microwave heating are with the lower side well 706. Technically, the upper side well 704 and the lower side well 706 are still one well as they are using the same wellhead at surface. Because of both buoyancy and the higher vertical permeability effects, the generated hydrogen and other gases 216 low upward and are produced from both upper side well 704 and lower side well 706. The heavier oil and water in target formation will flow downward because of gravity and pressure gradient. Once produced, the hydrogen is separated from syngas at surface. The CO₂ in separated gas is then re-injected into reservoir for CO₂ sequestration.

In some embodiments, the vertical distance between the upper side well and lower side wells varies from 5 meters to the formation thickness.

In some embodiments, the radiofrequency/microwave heating is either continuous, or pulsed, or intermittent, depending on the electricity from grid.

In some embodiments, the gas production rate and/or wellhead pressure is controlled so that the fluid flow rate from the formation to wellbore is consistent with the generation rate of hydrogen within the formation.

In some embodiments, the downhole controlling device is used in both the upper side well and lower side well to separately control fluid flow rate from the target formation to wellbore, according to the amount of hydrogen generated by the lower side well and the hydrogen accumulation near the upper side well.

In other embodiments, the upper side well may be closed to allow oil and water at the upper location of the target formation to flow downward to near lower side well under gravity. This provides more feedstock, i.e., oil and water, for hydrogen generation.

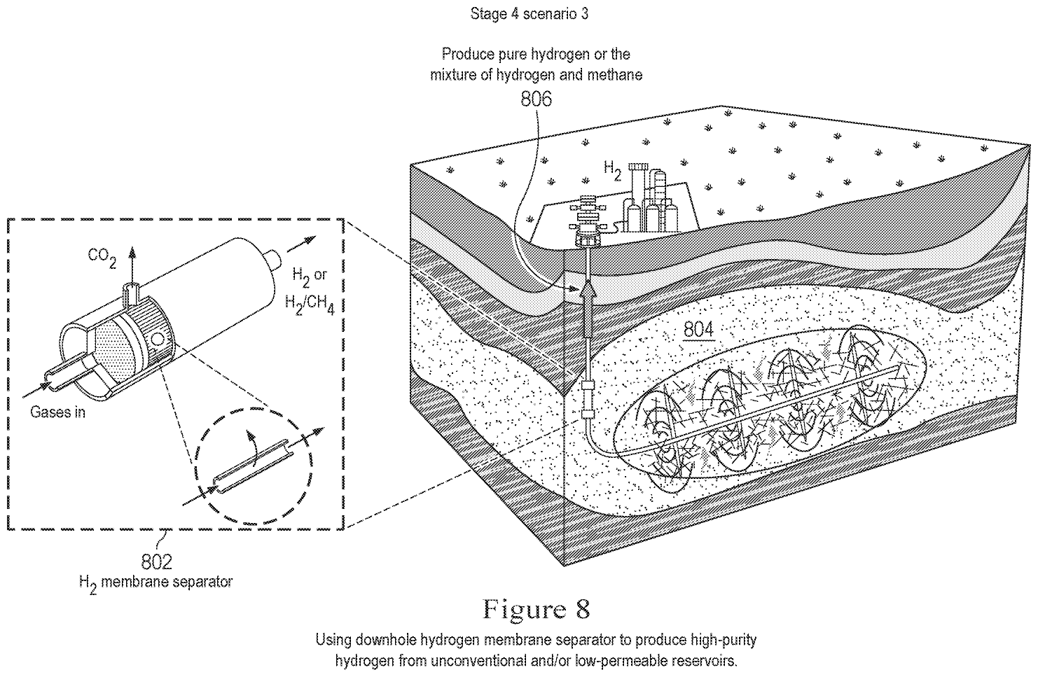

FIG. 8 is a schematic of scenario three for the hydrogen generation and production with the assistance of downhole hydrogen membrane separator 802 in unconventional or low-permeable oil and gas reservoirs 804 in accordance with one embodiment of the present invention. Different with FIG. 4, the downhole hydrogen membrane separator 802 only allows small-molecular hydrogen to pass through so that only hydrogen is produced to surface while all other gases remain in reservoirs. In some embodiments, the downhole hydrogen membrane separator 802 allows a mixture of hydrogen and methane to pass through. Thus, pure hydrogen or a mixture of hydrogen and methane can be produces 806.

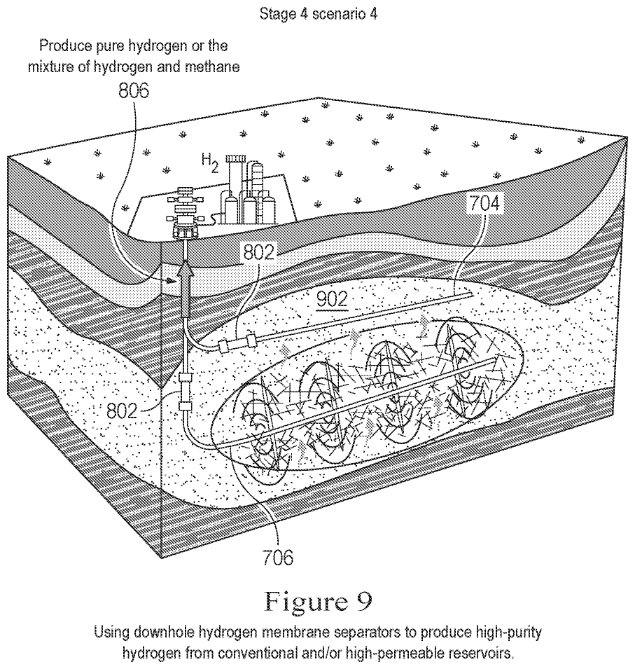

Turning to FIG. 9, a schematic of scenario four for the hydrogen generation and production with the assistance of downhole hydrogen membrane separators 802 in conventional or high-permeable oil and gas reservoirs 902 in accordance with one embodiment of the present invention is shown. The separators 802 are installed in both upper side well 704 and lower side well 706 so that high-purity hydrogen is produced simultaneously. In some embodiments, the downhole hydrogen membrane separator 802 allows a mixture of hydrogen and methane to pass through. Thus, pure hydrogen or a mixture of hydrogen and methane can be produces 806.

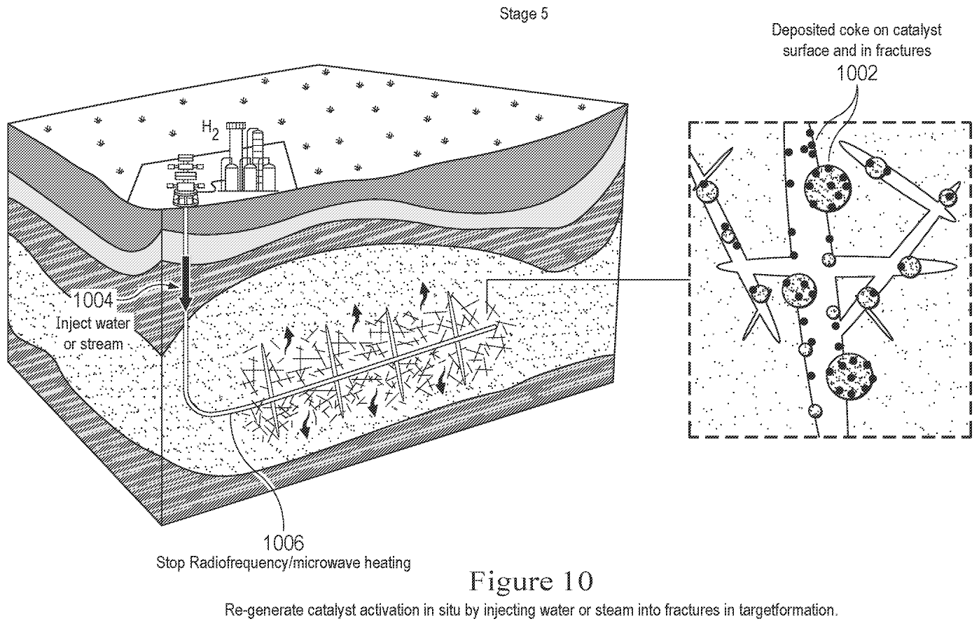

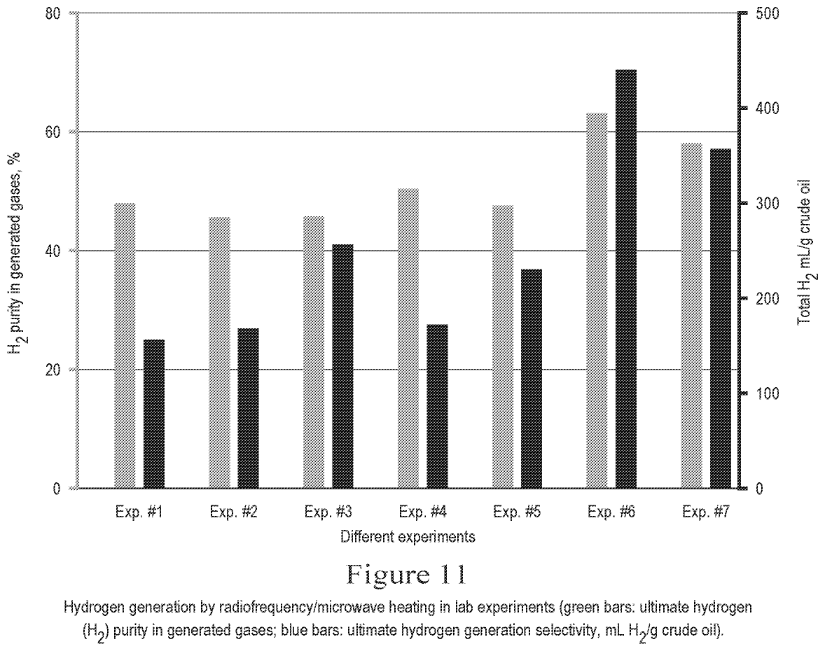

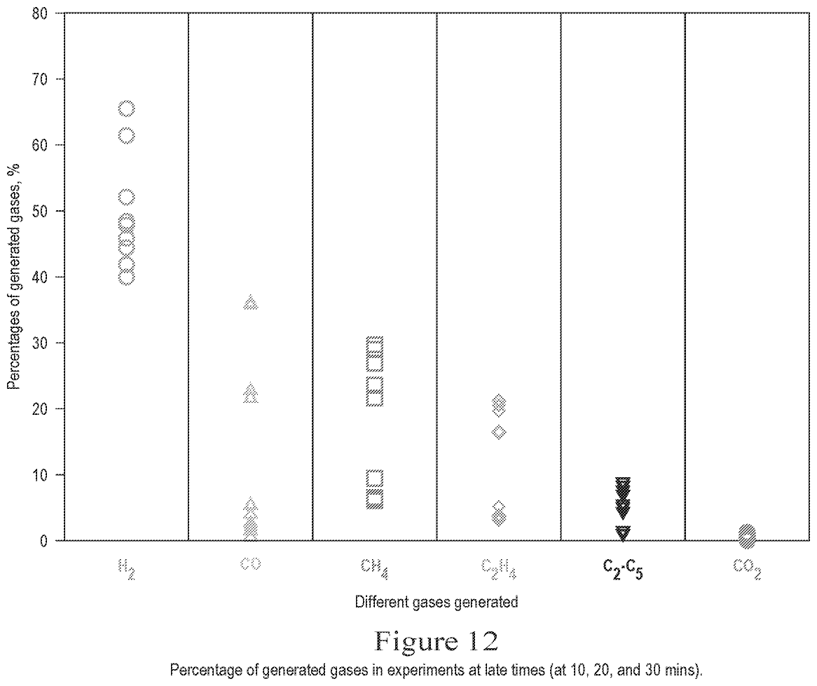

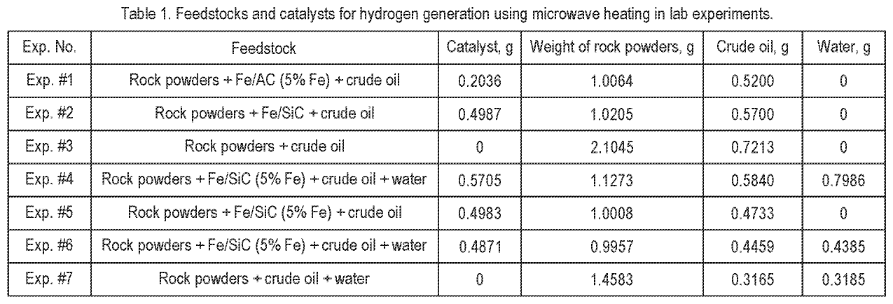

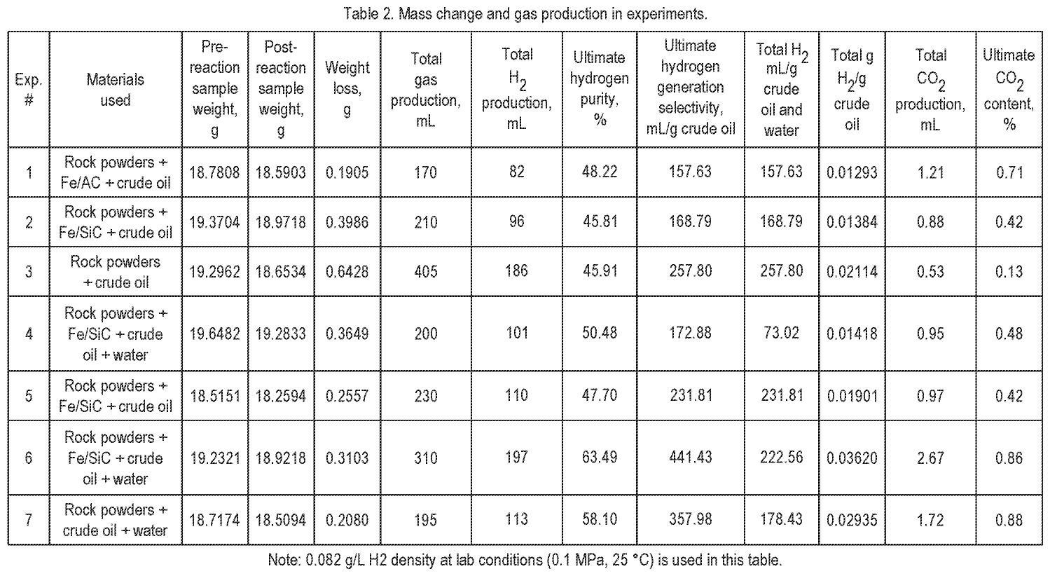

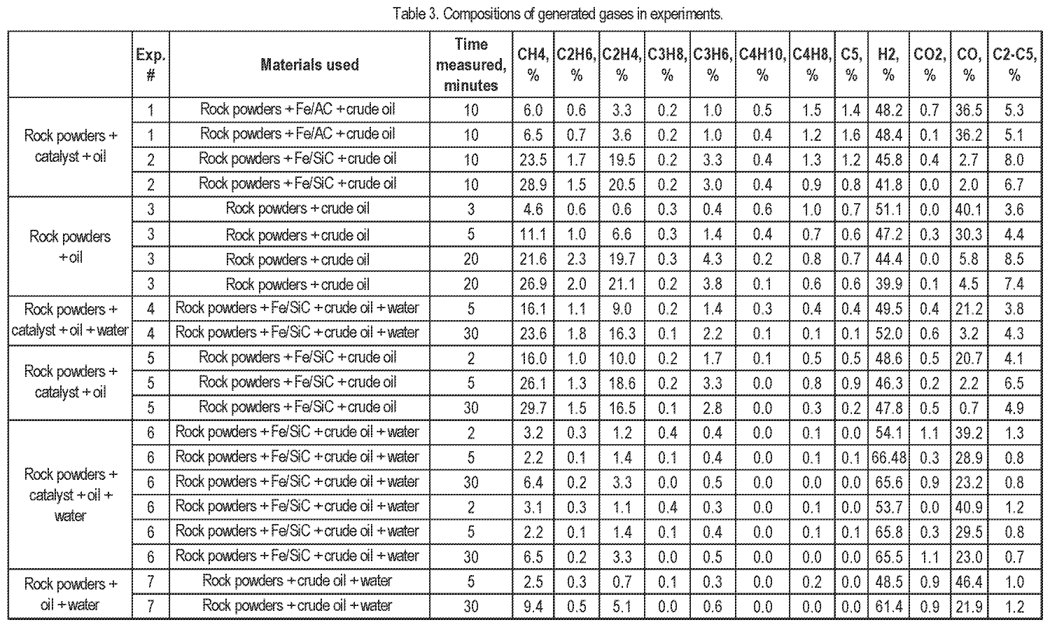

In some cases, a large number of solid coke 1002 is generated from hydrocarbon thermal cracking but cannot be removed by the coke-water reaction. The solid coke 1002 may deposit in surfaces of both fractures and catalysts, as shown in FIG. 10. The solid coke 1002 deposition can reduce the permeability of the target formation, thus reducing hydrogen transport from deeper formation to wellbore. Coke deposition on catalyst surface can also de-activate catalysts. Eventually, the hydrogen generation may stop. So, stage five is to re-generate catalyst in situ and remove solid coke in formation, either steam or water 1004 is injected through the well. With the high temperature in reservoirs and radiofrequency/microwave heating 1006, the coke can react with water in liquid and gas forms. Then, the permeability of target formation and the catalyst activation are recovered. One advantage is that the injected water or steam can react with coke and generate more hydrogen and syngas. Although oxygen was used to re-generate activation of catalyst at surface, it is not recommended because of the high possibility of explosion when oxygen contacts with the remaining hydrogen in the wellbore or target formation.

Stages four and five can be repeated for many cycles until the catalysts cannot be re-generated or the re-generated catalysts have low activation in formation. Stage six is for a repeated process from stages one to five (FIGS. 3 to 10). In this stage, the target formation is re-fractured and new catalyst particles, support materials, and propping agents are placed in the fracture network. The radiofrequency/microwave heating is again used for in-situ hydrogen generation in target formation for different scenarios. This process can also be repeated until the hydrogen generation is too low or not economic.

### Examples

The field pilot test using this invention is costly and impossible at the current stage in actual reservoir formation. However, the inventors validate this invention through lab experiments. Seven experiments were conducted in a 1.13 cm³ reactor with different combinations of catalysts, rock powders, crude oil, and water, as shown in Table 1.

The 5% Fe means there is 5% weight percentage of Fe catalysts in the mixture of Fe catalysts and support materials such as activated carbon (AC) and silicon carbide (SiC). The catalyst used herein is iron particles with diameters about 100 nm. The AC is a very good MW adsorber which favors quick heating in experiments. The SiC has excellent dielectric and mechanical thermal properties.

The 2.45 GHz frequency and 750 W power were used for microwave heating.

An infrared (IR) pyrometer was used to measure the temperature and accurately control the power of microwave generator.

The microwave heating process usually lasted for 10 to 40 minutes depending on the amount of feedstock in the reactor.

Table 2 lists the relevant metrics to evaluate hydrogen generation selectivity and hydrogen purity.

FIG. 9 shows the comparison of two metrics (ultimate H₂ generation selectivity and H₂ purity) for all seven experiments in accordance with one embodiment of the present invention. The hydrogen generation efficiencies show a wide range (157.63-441.43 mL H₂/g crude oil). The high purities of hydrogen generated are noteworthy, and they are around 45.81-63.49%. In contrast, the highest CO₂ content is negligible (i.e., less than 1%).

Table 3 shows the evolution of the compositions of gas streams, including H₂, CH+, CO, CO₂, C₂H₄, and other intermediate components C₂-C₅ (i.e., the sum of C₂H₆, C₃H₆, C₃H₈, C₄H₈, C₄H₁₀, and C₅). Some gas samples were measured twice.

FIG. 10 shows the comparison of the compositions for selected gas components at the (a) early and (b) late period in accordance with one embodiment of the present invention. Generally, the fraction of produced gas follows the ranking: H₂>CO>CH+>C₂H₄>C₂-C₅>CO₂. H₂ constitutes the largest volume fraction, and the ranges for all the tests are around 45.8-66.5% (Table 3), whereas CO₂ constitutes the smallest volume fraction (less than 1%). This is favorable to the mitigation of carbon emissions as one advantage of this microwave-initiated hydrogenation process. Overall, the H₂ fraction is the highest in all experiments at both the early and late periods of the tests.

### Other Embodiments

According to some embodiments, a method of generating and producing hydrogen from petroleum reservoirs is provided. The method includes conducting hydraulic fracturing through a horizontal well in an oil and gas formation; pumping the mixture of proppant and catalyst particles into fractures; pumping back the hydraulic fluids while leaving catalysts in reservoirs; heating the reservoirs using radiofrequency/microwave to generate syngas (e.g., hydrogen and other gases) within reservoirs; producing syngas through a single horizontal well from low-permeable unconventional reservoir or through both upper side well and lower side well from high-permeable conventional reservoirs; and/or installing downhole hydrogen membrane separator and only produce hydrogen through either the single well from shale reservoirs or two horizontal wells (e.g., lower side well and upper side well) from conventional reservoirs; injecting water or steam to re-generate the catalysts in situ and resume formation permeability; re-starting radiofrequency/microwave heating to generate and produce hydrogen; and re-fracturing formation and placing new catalysts for hydrogen generation.

According to some embodiments, the method includes integrating radiofrequency/microwave heating with hydraulic fracturing within petroleum reservoirs to create high permeable fractures to create suitable environment for generating and producing hydrogen in situ.

According to some embodiments, the method includes placing catalysts in different size (i.e., diameter from nanometer to millimeter) in large and micro-fractures to promote heating effects by the radiofrequency/microwave absorbers, i.e., the catalysts and/or reservoir fluids such as water, and to create high enough temperature near the wells in reservoirs.

According to some embodiments, the method includes heating the catalyst surface to a temperature up to 1000° C. in a certain distance near the microwave antenna.

According to some embodiments, the method includes heating the reservoir formation to a temperature from 100° C. to up to 800° C. in a certain distance near the microwave antenna.

According to some embodiments, the method includes enhancing hydrogen generation and yield through the superhot catalyst particles and catalytic effects in hydrocarbon thermal cracking, coke-water reaction, and water-gas-shift reaction within reservoirs.

According to some embodiments, the method includes creating highly permeable fractures for generated hydrogen flowing from reservoirs to wellbores.

According to some embodiments, the method includes providing flexible ways to produce syngas with surface separation and only hydrogen by hydrogen membrane separators.

According to some embodiments, the method includes providing flexible ways to produce hydrogen and/or syngas from either a single horizontal well or a well design with an upper side well and a lower side well according to reservoir permeabilities and fluid flow performance.

According to some embodiments, the method includes injecting steam or water to re-generate catalysts in situ by removing deposited coke on catalyst surface.

According to some embodiments, the method includes injecting steam or water to remove deposited coke in fractures and resume permeability of fractures.

According to some embodiments, the method includes re-fracturing and re-placing catalysts in reservoirs to enhance hydrogen generation.

According to some embodiments, the method includes using a wide range of electromagnetic frequency ranging from less than 100 Hz to above 100 GHz for heating and hydrogen generation.

According to some embodiments, the method includes adjusting the electromagnetic frequency according to the time-varying water and oil and gas saturation in reservoirs in order to penetrate deeper reservoirs and heat larger area/volume.

According to some embodiments, the method includes using electricity generated by fossil fuels.

According to some embodiments, the method includes using peak electricity from renewable energy such as wind and solar energy for radiofrequency/microwave heating during the hydrogen generation process.

According to some embodiments, the method includes applying this method in various petroleum reservoirs including conventional reservoirs, heavy oil and bitumen reservoirs, shale oil and shale gas reservoirs, oil shale reservoirs and so on.

According to some embodiments, the method includes applying this method in both new; in-production, and depleted/abandoned petroleum reservoirs.

It will be understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property (ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least #1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

Howarth, R. W., and Jacobson, M. Z., 2021. How green is blue hydrogen? Energy Sci Eng. 00:1-12.
Jie, X., Gonzalez-Cortes, S., Xiao, T. et al. 2019. The decarbonisation of petroleum and other fossil hydrocarbon fuels for the facile production and safe storage of hydrogen. Energy Environ. Sci. 12 (1): 238-249.
Strem, G., Gates, I. D., and Wang, Y., 2020, In-situ process to produce synthesis gas from underground hydrocarbon reservoirs, WO2019169492A1.
Yuan, Q., Jie, X., Ren, Bo., 2021. High-purity, CO₂-free hydrogen generation from crude oils in crushed rocks using microwave heating. Presented at the SPE Annual Technical Conference and Exhibition, 21-23 Sep. 2021, Dubai, U.A.E.

1. A method for generating hydrogen within a petroleum reservoir and producing the hydrogen, the method comprising:
providing one or more wellbores into the petroleum reservoir from a surface, wherein the petroleum reservoir contains fractures by hydraulic fracturing;
heating catalyst particles within the fractures of the petroleum reservoir using electromagnetic waves, wherein the heated catalyst particles generate a syngas from hydrocarbons within the petroleum reservoir;
separating the hydrogen from the syngas at the surface or within the one or more wellbores; and
producing the hydrogen at the surface or to the surface.

2. The method as recited in claim 1, wherein the one or more wellbores further comprise one or more horizontal wellbores.

3. The method as recited in claim 2, wherein the one or more horizontal wellbores comprise one or more upper side wells and one or more lower side wells.

4. The method as recited in claim 3, wherein the heating is performed using the one or more lower side wells, and the syngas is produced using the one or more upper side wells.

5. The method as recited in claim 1, further comprising:
positioning one or more antennas within the petroleum reservoir, wherein the one or more antennas are connected to a power source at the surface; and
generating the electromagnetic waves using one or more antennas.

6. The method as recited in claim 5, wherein:
the catalyst particles proximate to the one or more antennas are heated to a temperature of up to 1000° C.; and
a rock or hydrocarbons within the petroleum reservoir are heated to a temperature of about 100° C. to up to 800° C.

7. The method as recited in claim 1, wherein the electromagnetic waves are continuous, pulsed, intermittent, time dependent or time independent.

8. The method of claim 1, wherein the catalyst particles are heated for a time period of hours, days, seasons or years.

9. The method as recited in claim 1, wherein the electromagnetic waves have a frequency from about 100 Hz to about 100 GHz.

10. The method as recited in claim 9, further comprising adjusting the frequency according to saturations of water, oil and gas in the hydrocarbon reservoir.

11. The method as recited in claim 1, wherein the syngas comprises the hydrogen, carbon monoxide and carbon dioxide.

12. The method as recited in claim 1, wherein the hydrogen comprises a mixture of the hydrogen and methane.

13. The method as recited in claim 12, wherein:
the mixture of the hydrogen and the methane is separated from the syngas using membrane separators; and
co-transporting the mixture of the hydrogen and the methane using natural gas pipelines.

14. The method as recited in claim 1, further comprising injecting or sequestering CO₂ in the petroleum reservoir.

15. The method as recited in claim 1, wherein:
the catalyst particles comprise iron catalysts, nickel catalysts, or titanium oxide (TO);
a size of the catalyst particles ranges from nanometers to millimeters; or
a shape of catalysts comprises tri-lobe, spherical, or agglomerated.

16. The method as recited on claim 1, further comprising injecting the catalyst particles into the fractures within the petroleum reservoir in a continuous, pulsed, or slug manner.

17. The method as recited in claim 1, wherein the catalyst particles are contained within a polymer fluid.

18. The method as recited in claim 17, wherein the catalyst particles are injected a pressure greater than a fracturing pressure of the petroleum reservoir.

19. The method as recited in claim 17, further comprising injecting a buffer fluid into the petroleum reservoir.

20. The method as recited in claim 17, wherein support materials or propping agents are also injected into the fractures.

21. The method as recited in claim 20, wherein the support materials comprise activated carbon (AC) or silicon carbide (SiC).

22. The method as recited in claim 21, wherein a ratio of the propping proppant agents to the catalyst particles comprises a range of about 0 to 100%.

23. The method as recited in claim 1, further comprising injecting steam or water into the hydrocarbon reservoir to re-generate the catalyst particles in-situ by removing coke deposited on a surface of the catalyst particles or in the fractures.

24. The method as recited in claim 1, further comprising creating the fractures within the petroleum reservoir using hydraulic fracturing.

25. The method as recited on claim 1, further comprising re-fracturing the petroleum reservoir and re-placing the catalyst particles in the petroleum reservoir.

26. A system for generating hydrogen within a petroleum reservoir and producing the hydrogen comprising:
one or more wellbores into the petroleum reservoir from a surface, wherein the petroleum reservoir contains fractures by hydraulic fracturing;
a power source at the surface;
one or more antennas within the petroleum reservoir and connected to the power source;
catalyst particles within the fractures of the petroleum reservoir, wherein the one or more antennas generate electromagnetic waves that heat the catalyst particles, which generate a syngas from hydrocarbons within the petroleum reservoir; and
one or more hydrogen separators located within the one or more wellbores or at the surface that separate the hydrogen from the syngas.

27-49. (canceled)
